(19) United States
(12) Patent Application Publication
(10) Pub. No.: US 2015/0186979 A1
(43) Pub. Date: Jul. 2, 2015

(54) SYSTEMS AND METHODS FOR TRACKING SALES AND PROVIDING SALES CHANNEL CREDIT

(71) Applicant: TOSHIBA GLOBAL COMMERCE SOLUTIONS HOLDINGS CORPORATION, Tokyo (JP)

(72) Inventors: David Bernath, Cary, NC (US); Julia Bond, Youngsville, NC (US); William Noonan, Cary, NC (US); Jeffrey J. Smith, Raleigh, NC (US)

(73) Assignee: TOSHIBA GLOBAL COMMERCE SOLUTIONS HOLDINGS CORPORATION, Tokyo (JP)

(21) Appl. No.: 14/177,525

(22) Filed: Feb. 11, 2014

Related U.S. Application Data
(60) Provisional application No. 61/922,051, filed on Dec. 30, 2013.

(51) Int. Cl. G06Q 30/06; G06Q 20/38

(52) U.S. Cl. CPC G06Q 30/0635; G06Q 20/38

(57) ABSTRACT

Systems and methods for tracking sales and providing sales channel credit are disclosed. According to an aspect, a method may include creating as sales order for the purchase of one or more products. The method may also include adding the product(s) to the sales order. Further, the method may include creating a transaction number representing a sales channel and the product(s). The method may also include assigning the transaction number representing the sales channel to the sales order. Further, the method may include storing the sales order.

### CROSS REFERENCE TO RELATED APPLICATION

This application claims the benefit of U.S. Provisional Patent Application No. 61/922,051, filed Dec. 30, 2013 and titled SYSTEMS AND METHODS FOR TRACKING SALES AND PROVIDING SALES CHANNEL CREDIT, the content of which is hereby incorporated herein by reference in its entirety.

### TECHNICAL FIELD

The present invention relates to retail devices and equipment, and more specifically, to systems and methods for tracking sales and providing sales channel credit.

### BACKGROUND

In retail environments, such as electronic, home improvement, clothing stores, and other “brick and mortar” stores, as examples, retail personnel interact with and aid customers in the purchase of products. Additionally, web store fronts may retail or sell products by or on behalf of these stores, however, the web store fronts may or may not be established by the “brick and mortar” stores. The web store fronts may be represented by an Internet retailer and not the “brick and mortar” store. In an example, online retailers may represent a sales or distribution channel for sales of computers or electronics products, but online retailers may or may not be the manufacturers of the computers or electronics products. The online retailer may only represent a means for additional or incremental sales of products for the computer or electronic product manufacturer. As a further example, this can also apply to home improvement products, such as faucets. A particular brand of faucet may be represented by an online retailer or the more traditional “brick and mortar” home improvement retailers. While it may be relatively easy to shop online from the convenience of home via the online retailer, the customer may still have the need to see the product, physically measure the product or speak with retail personnel more knowledgeable about the product. Similarly, a customer may see a product in a store, become adequately informed by the retail personnel to purchase the product, however, want to speak with a friend or spouse regarding the purchase at home or away from the “brick and mortar” store. All of these sales channels have merit and add value to the sales process.

However, if the sales process starts with the online retailer but is paid for and closes in the “brick and mortar” retail store, the online retailer may not be properly credited for initiating the sales process in that sales transaction. Similarly, if the retail personnel are not adequately recognized and compensated the retail stores may have difficulty properly compensating the retail personnel. In addition, if a particular sales channel is responsible for a majority of the sales for a retail establishment it is reasonable for a retail establishment to want to place greater emphasis in promoting this particular sales channel over other sales channels. There is a need for devices and techniques that provide a more versatile solution for a retail establishment to track sales and properly credit sales channels.

### SUMMARY

Disclosed herein are systems and methods for tracking sales and providing sales channel credit. According to an aspect, a method may include creating as sales order for the purchase of one or more products. The method may also include adding the product(s) to the sales order. Further, the method may include creating a transaction number representing a sales channel and the product(s). The method may also include assigning the transaction number representing the sales channel to the sales order. Further, the method may include storing the sales order.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; however, the presently disclosed subject matter is not limited to the specific methods and instrumentalities disclosed. In the drawings:

FIG. 1 is a block diagram of an example system for tracking sales and providing sales channel credit according to embodiments of the present invention;

FIG. 2 is a block diagram showing a hierarchy of the sales order and transaction number relationship according to embodiments of the present invention; and

FIG. 3 is a flowchart of an example method for creating a sales order and transaction in accordance with embodiments of the present invention; and

FIG. 4 is a flowchart of an example method of using existing sales order and transaction, including the creation of a new transaction, in accordance with embodiments of the present invention.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

As referred to herein, the term “computing device” should be broadly construed. It can include any type of device including hardware, software, firmware, the like, and combinations thereof. A computing device may include one or more processors and memory or other suitable non-transitory, computer readable storage medium having computer readable program code for implementing methods in accordance with embodiments of the present invention. A computing device may be, for example, retail equipment such as POS equipment. In another example, a computing device may be a server or other computer located within a retail environment and communicatively connected to other computing devices (e.g., POS equipment or computers) for managing accounting, purchase transactions, and other processes within the retail environment. In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD). A computing device can also include any type of conventional computer, for example, a laptop computer or a tablet computer. A typical mobile computing device is a wireless data access-enabled device (e.g., an iPHONE® smart phone, a BLACKBERRY® smart phone, a NEXUS ONE™ smart phone, an iPAD® device, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on smart phone, the examples may similarly be implemented on any suitable computing device, such as a computer.

As referred to herein, the term “user interface” is generally a system by which users interact with a computing device. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

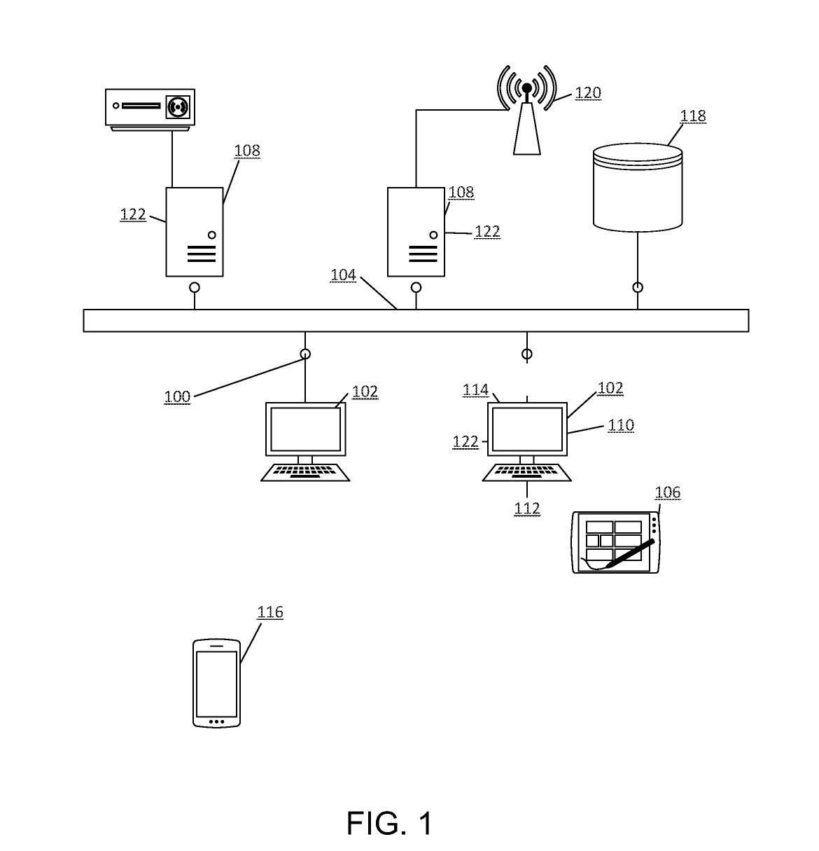

The presently disclosed invention is now described in more detail. For example, FIG. 1 illustrates a block diagram of a system 100 according to embodiments of the present invention. The system 100 may be implemented in whole or in part in any suitable environment, such as a retail environment. For example, the system 100 may be implemented in a retail store having a variety of products or items for purchase and one or more point of sale (POS) terminals. For example, a computing device 102 may operate as a POS device that can be operated by retail personnel for conducting purchase transactions with customers or for processing products within the retail environment (e.g., inventory of products). The computing device 102 may be communicatively connected via a communications network 104, which may be any suitable local area network (LAN), either wireless (e.g., BLUETOOTH® communication technology) and/or wired. The computing device 102, a tablet device 106 in communication with the computing device 102, and other components, not shown, may be configured to acquire data within the retail environment, to process the data, and to communicate the data to a centralized server 108. For example, the computing device 102 and tablet device 106 may operate together to implement a retail function and to communicate data related thereto to the server 108. The server 108 may reside in the retail store or be remotely located.

The components of the system 100 may each include hardware, software, firmware, or combinations thereof. For example, software residing in memory of a respective component may include instructions implemented by a processor for carrying out functions disclosed herein. As an example, the computing device 102 may each include a user interface 110 including a display (e.g., a touchscreen display), a barcode scanner, and/or other equipment for interfacing with retail personnel and for conducting a purchase transaction for purchase of items by customers. The computing device 102 may also include memory 112. The computing device 102 may be configured to implement POS functionality. The computing device 102 may also include a suitable network interface 114 for communicating with the network 104. The tablet device 106 may include hardware (e.g., image capture devices, scanners, and the like) for capture of various data within the retail environment. For example, the tablet device 106 may include an image capture device (e.g., a camera) for capturing one or more images of a retail item (e.g., a product) and interaction of a user's hand or finger with the item. In another example, the tablet device 106 may include a scanner for scanning items for inventory or for POS functions (e.g., customer purchase of a scanned product). The system 100 may also include a smart phone device 116 configured similarly to the tablet device 106. The system 100 may also comprise a database 118 for storage of online orders, sales order and transaction history. Further, the server 108 may be connected to the computing devices 102 via the network 104 or via a wireless network 120.

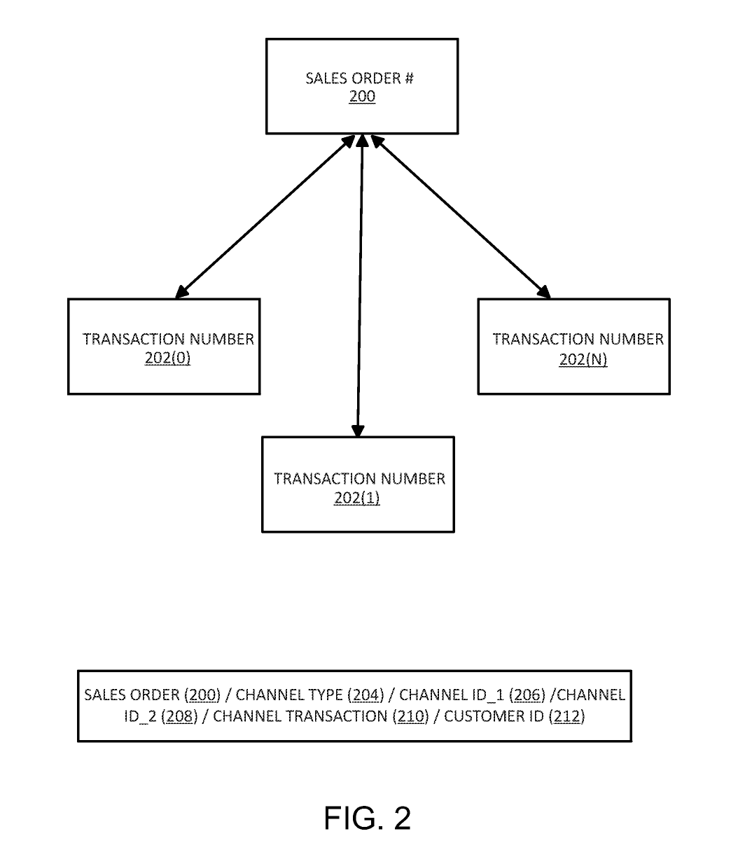

In continuing reference to FIG. 1, illustrated is a block diagram of the system 100 for tracking sales and providing sales channel credit according to embodiments of the present invention. The system 100 comprising at least a processor and memory of a computing device and a retail function manager 122 is provided. As will be described in further detail in FIGS. 2-4 the retail function manager 122 is configured to create a sales order for the purchase of at least one product. To create a sales order for the purchase of one or more products, the retail function manager 122 is configured to add one or more products, create a transaction number representing a sales channel and the at least one product, and assign the transaction number representing the sales channel to the sales order. Further, the retail function manager 122 is configured to store the sales order in the database 118. It should be noted that the database 118 may be located either internal or external to the servers 108.

In this regard, FIG. 2 illustrates a block diagram illustrating a data model hierarchy of a sales order 200 and a transaction number relationship according to embodiments of the present invention. The sales order 200 identifies an order, but there is also a transaction number 202(0)-202(N) that is used to track critical events within the life an order. The sales order 200 may have one or N multiple transaction numbers 202(0)-202(N). Each transaction number 202(0)-202(N) is coded to include the sales order 200 to which it belongs, a channel type 204, a channel ID_{—}1 206, a channel ID_{—}2 208, a channel transaction number 210 and a customer ID 212. The transaction number 202 is a unique identifier which identifies a transaction event. The transaction event corresponds to an event when a customer or retail personnel initiate an inquiry or add a product to a shopping cart. It may be a unique instance defining customer transaction activity. The transaction number 202(0)-202(N) is associated with a sales order 200, however, the transaction number 202(0)-202(N) may have unique components, wherein a different channel ID_{—}1 206 or a different customer ID 212 are assigned. The channel type 204 is coded as appropriate to uniquely identify the type of sales channel through which the transaction is being transacted. For example, the channel type 204 may be associated with a “bricks and mortar” store, an online web site operated by the “bricks and mortar” store, or even an online web site not operated or affiliated with the “bricks and mortar” store. The channel ID_{—}1 206 corresponds to a unique instance of a channel type 204. For example, a “bricks and mortar” store at one address would have a different channel ID 206 from a “bricks and mortar” store at a different address, while both “bricks and mortar” stores may share the same channel type 204. The channel ID_{—}2 208 corresponds to the necessary identification for a particular employee of the retail establishment. The channel transaction number 210 is a unique transaction number that uniquely identifies a particular transaction for a particular channel ID_{—}1 206 and channel ID_{—}2 208. Further, the customer ID 212 may uniquely identify the customer transacting the particular transaction number 202(0)-202(N). In this manner, the transaction number 202(0)-202(N) provides the necessary unique and identifying context to provide the proper crediting of the sale to the appropriate channels and/or personnel.

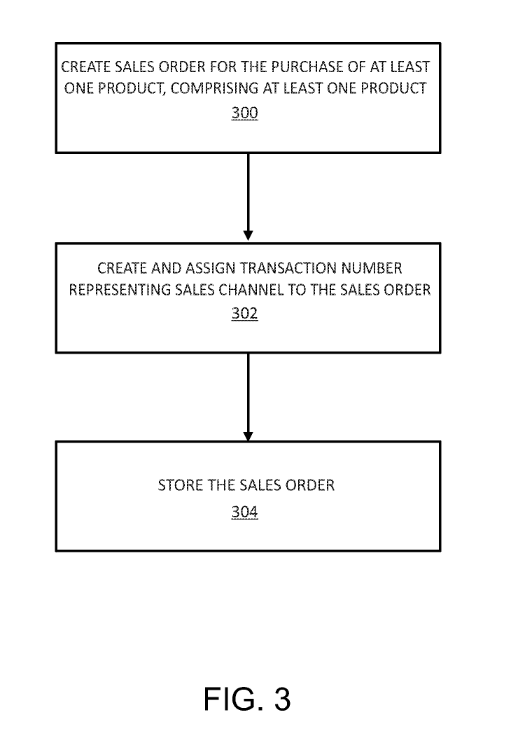

In this regard, FIG. 3 is a flowchart showing creation of a sales order and a transaction number in accordance with embodiments of the present invention. It is noted that the example method may be implemented by a retail function manager, although it should be understood that the method may be implemented by one or more components of one or more computing devices of any suitable type. Further, the example method may be implemented in any suitable environment such as, but not limited to, the system shown in FIG. 1. In this example, reference is made to FIG. 2 within which the sales order 200 and transaction number 202(0)-202(N) are created.

The method of FIG. 3 includes creating 300 a sales order 200 for the purchase of one or more products. The product(s) may be added to the sales order 200.

Further, the method of FIG. 3 includes creating and assigning 302 a transaction number representing a sales channel to the sales order. Continuing the aforementioned example, a retail function manager may create a transaction number 202(0)-202(N) representing a sales channel and the product(s). Further, the retail function manager may assign the transaction number representing the sales channel to the sales order.

The method of FIG. 3 includes storing 304 the sales order. Continuing the aforementioned example, the sales order may be stored in the database described in FIG. 1.

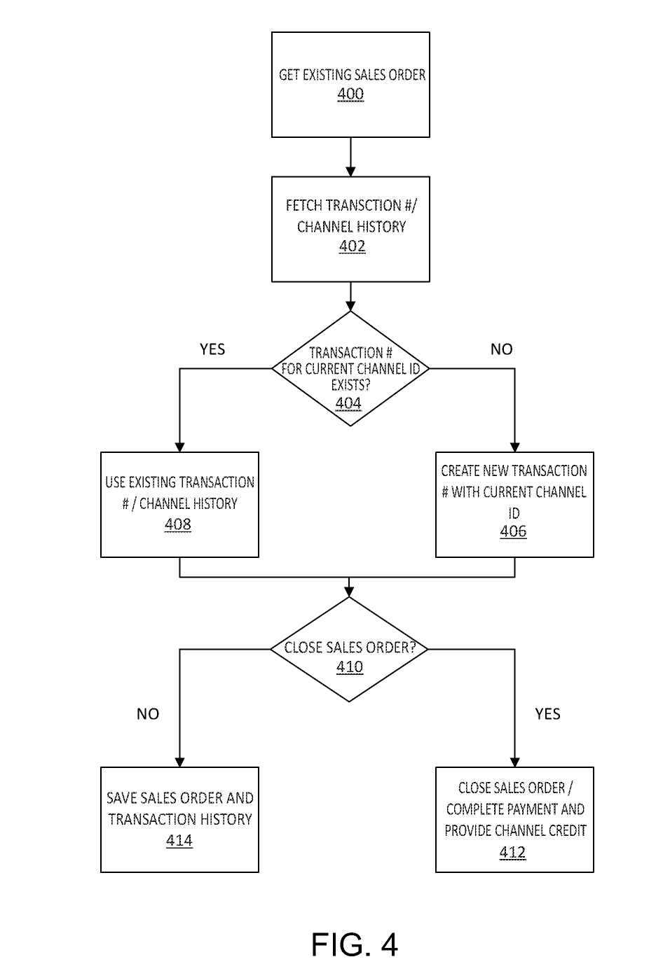

In this regard, FIG. 4 is a flowchart showing an example method of using an existing sales order and transaction number in accordance with embodiments of the present invention. It is noted that the example method may be implemented by a retail manager, although it should be understood that the method may be implemented by one or more components of one or more computing devices of any suitable type. Further, the example method may be implemented in any suitable environment such as, but not limited to, the system shown in FIG. 1. In this example, reference is made to FIG. 2 within which the sales order 200 and transaction number 202(0)-202(N) are created.

The method of FIG. 4 includes retrieving, fetching, or otherwise getting 400 an existing sales order. For example, the sales order 200 record may be retrieved. In response to determining that the sales order 200 exists, the retail function manager 122 may retrieve or fetch 402 the sales order 200 and any associated transaction numbers 202(0)-202(N) containing the channel transaction history. The retail function manager 122 may identify the current channel type 204, channel ID_{—}1 206, and channel ID_{—}2 208.

At block 404, the method includes determining whether the transaction number for the current ID channel exists. Continuing the aforementioned example, in response to the retail function manager 122 determining that the current channel type 204, channel ID_{—}1 206, or channel ID_{—}2 208 do not exist in the history of transactions included in the sales order 200 record retrieved, a new transaction number 202(0)-202(N) may be created 406, including the associated channel type 204, channel ID_{—}1 206 and channel ID_{—}2 208 for the current channel transacting the new transaction number 202(0)-202(N). In response to determining that the current channel transacting the transaction is found in the sales order 200 history, the retail function manager 122 may use 408 the corresponding transaction number 202(0)-202(N). For example, the corresponding transaction number 202(0)-202(N) is used if the channel ID_{—}1 206 and channel ID_{—}2 208 representing the same retail personnel is found in the sales order 200 history.

At block 410, it is determined 410 whether to close the sales order. If the sales order 200 is closed, the sales order 200 may complete payment and provides the appropriate channel credit according to store policy (block 412). If the sales order 200 is not closed, but rather is saved for future use or modification (block 414) the retail function manager 122 may store the sales order 200 and the associated transaction number 202(0)-202(N) history in the database 118.

In this manner, as an example, the customer at home using the web site for retail establishment, may add items to their online shopping cart. The customer realizes that they have questions concerning one or more items in the online shopping cart, so the customer saves the online shopping cart, wherein the retail function manager 122 creates a sales order 200 and decides to drive to the “bricks and mortar” store. The customer wants to see the items or consult with a retail associate regarding the items placed in the online shopping cart. The retail associate consults with the customer regarding their questions, and they decide to purchase the items initially stored in the online shopping cart and possibly additional items. The retail associate brings their order up in the store close out the sales order 200. The order is completed and appropriate credit and/or compensation according to the retail establishment's credit and compensation policy is credited. Post analysis of the sales order 200 history can show that there were two transaction numbers assigned to the sales order 200, the transaction number 202(0)-202(N) from the online shopping cart and the transaction number 202(0)-202(N) from the store. This information can then be used to provide revenue credit for the items in the sales order 200 based on company policies for splitting revenue to the channels. The reverse may also be the case, wherein a sales order 200 is initiated in the “bricks and mortar” store with the aid of the retail personnel and closed out in an online shopping cart from a remote location (e.g., home, etc.). Additionally, other online web sites not operated by the “bricks and mortar” store may be incorporated into the process of initiating, modifying or closing the sales order 200 as directed by the retail personnel or customer. Closing the sales order comprises assigning a payment type, wherein the payment type is the means by which the customer pays for the sales order. Further, the closing of the sales order comprises converting the sales order to a sales transaction in the database 118.

As an additional example, a customer may come into the store to look at items. They may walk around with the retail personnel with a tablet, discussing items, and adding them into a sales order 200. The customer may want to think about their purchase, so the retail personnel saves the sales order 200. The customer goes home, possibly consulting with others and decides they want to buy. The customer could go into the sales order 200 via an online shopping cart from a web site, bring up their sales order 200 and close it with their credit card. The retail personnel who helped in the store would still be associated with the items and both channels are reflected in the order through the transaction number tracking.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A method comprising:
creating a sales order for the purchase of at least one product;
adding the at least one product to the sales order;
creating a transaction number representing a sales channel and the at least one product;
assigning the transaction number representing the sales channel to the sales order; and
storing the sales order.

2. The method of claim 1, wherein creating the sales order comprises determining whether the sales order existed before creating the sales order.

3. The method of claim 3, wherein creating the sales order comprises determining whether the transaction number representing the sales channel and the at least one product existed before creating the sales order.

4. The method of claim 3, further comprising:
closing the sales order; and
assigning a payment type.

5. The method of claim 4, wherein closing the sales order comprises converting the sales order to a sales transaction.

6. The method of claim 5, wherein closing the sales order comprises crediting each of the sales channels represented in each of the corresponding transaction numbers with credit according to a store policy.

7. The method of claim 1, wherein the sales order for the purchase of at least one product is performed via a web browser of a computing device external to a retail establishment.

8. The method of claim 1, wherein the sales order for the purchase of at least one product is performed via one of a personal digital assistant (PDA), tablet computer, and a web browser of a computing device in a retail establishment.

9. A system comprising:
at least a processor and memory of a computing device; and
a retail function manager configured to:
create a sales order for the purchase of at least one product;
add at least one product to the sales order;
create a transaction number representing a sales channel and the at least one product;
assign the transaction number representing the sales channel to the sales order; and
store the sales order.

10. The system of claim 9, wherein the retail function manager is configured to determine whether the sales order existed before creating the sales order.

11. The system of claim 10, wherein the retail function manager is configured to determine whether the transaction number representing the sales channel and the at least one product existed before creating the sales order.

12. The system of claim 10, wherein the retail function manager is configured to:
close the sales order; and
assign a payment type.

13. The system of claim 12, wherein the retail function manager is configured to convert the sales order to a sales transaction.

14. The system of claim 13, wherein the retail function manager is configured to credit each of the sales channels represented in each of the corresponding transaction numbers with credit according to a store policy.

15. The system of claim 9, wherein the sales order for the purchase of at least one product is performed via a web browser of a computing device external to a retail establishment.

16. The system of claim 9, wherein the sales order for the purchase of at least one product is performed via one of a personal digital assistant (PDA), tablet computer, and a web browser of a computing device in a retail establishment.

17. A computer program product comprising a computer readable storage medium having program instructions embodied therewith, the program instructions executable by a computing device to cause the computing device to:
create, by the computing device, a sales order for the purchase of at least one product;
add, by the computing device, at least one product to the sales order;
create, by the computing device, a transaction number representing a sales channel and the at least one product;
assign, by the computing device, the transaction number representing the sales channel to the sales order; and
store, by the computing device, the sales order.

18. The computer program product of claim 17, wherein the program instructions are executable by the computing device to cause the computing device to determine whether the sales order existed before creating the sales order.

19. The computer program product of claim 18, wherein the program instructions are executable by the computing device to cause the computing device to determine whether the transaction number representing the sales channel and the at least one product existed before creating the sales order.

20. The computer program product of claim 18, wherein the program instructions are executable by the computing device to cause the computing device to close the sales order and to assign a payment type.

21. The computer program product of claim 20, wherein the program instructions are executable by the computing device to cause the computing device to convert the sales order to a sales transaction.

22. The method of claim 21, wherein the program instructions are executable by the computing device to cause the computing device to credit each of the sales channels represented in each of the corresponding transaction numbers with credit according to a store policy.
